(19) United States
(12) Patent Application Publication
(10) Pub. No.: US 2023/0406009 A1
(43) Pub. Date: Dec. 21, 2023

(54) Method and Assembly for Producing a Flat Printed Packaging Material

(71) Applicant: Value & Intellectual Properties Management GMBH, Bruckmühl (DE)

(72) Inventor: Kai K.O. Bär, Bad Aibling (DE)

(73) Assignee: Value & Intellectual Properties Management GMBH, Bruckmühl (DE)

(21) Appl. No.: 18/034,982

(22) PCT Filed: Nov. 3, 2021
(86) PCT No.: PCT/EP2021/080433

§ 371 Date: May 2, 2023

(30) Foreign Application Priority Data
Nov. 3, 2020 (DE) 10 2020 128 849.2

(51) Int. Cl. B41J 11/00; B41J 11/04; B41J 3/407; B41J 29/377; B41M 7/00

(52) U.S. Cl. CPC B41J 11/00216; B41J 11/00214; B41J 11/00222; B41J 11/00242; B41M 7/0081; B41J 11/04; B41J 3/407; B41J 29/377; B41J 11/0085

(57) ABSTRACT

The invention relates to a method and an assembly for producing a flat printed packaging material, having the steps of:—providing a quasi-endless web of the packaging material on a first web roller or—providing a sheet of the flat packaging material on a first sheet stack,—unwinding or receiving and transporting the packaging material by means of at least one printing station for printing a surface of the packaging material,—subsequently transporting the packaging material through at least one drying station in order to dry the printing on the packaging material, and—winding the printed and dried packaging material onto a second web roller or—depositing the printed and dried packaging material onto a second sheet stack, wherein the drying process in the drying station comprises an irradiation process using electromagnetic radiation with a radiation density maximum in the near-infrared range and with a high power density, in particular between 100 and 800 kW/m2, and the packaging material is transported at least through the drying station on a thermally conductive carrier with an adjustable temperature.

The invention relates to a method for producing a flat printed packaging material in accordance with the generic concept of claim 1, and also relates to an assembly for the execution of such a method.

Today's retail world, especially that of supermarkets in the food sector, but also online retail, would be unthinkable without the elaborately and richly printed packaging of flat packaging material. The highly efficient and cost-effective production of flat printed packaging material has gained correspondingly in importance in recent decades. A great deal of development effort has gone into the use of ever-thinner materials and the increase in quality and reduction in cost of multi-coloured printed materials.

Today, the printing of the packaging material is often carried out in inkjet printing stations with printing inks in various colours, and drying stations have become widely established for the drying of the printing, in which the printed packaging material is exposed to electromagnetic radiation with a radiation density maximum in the near-infrared range (approx. 800-1500 nm; NIR radiation). Since a certain heating of the material inevitably occurs during the high-energy irradiation, a cooling of the material is usually provided.

However, it has been shown that both quality and reliability problems can arise in this context.

The invention is therefore based on the object of providing an improved method of the type described, which, in particular, provides improvements with regard to the quality of the printed packaging material produced, and/or with regard to reliable process control. Furthermore, an assembly for the execution of such an improved method is to be provided.

These and, where possible, further objects are achieved in accordance with the aspect of the inventive method by a method with the features of claim 1, and in accordance with aspect of the inventive device, by an assembly with the features of claim 20. Appropriate further developments of the inventive concept are the subject of the respective dependent claims.

The invention includes the concept of transport of the flat packaging material through the region of a drying station operating with NIR radiation on a thermally-conductive carrier with an adjustable temperature.

A corresponding drying station comprises in particular at least one, but usually a plurality of, linear halogen radiators, which are operated at a radiator temperature that causes the emission of NIR radiation, and to which one or a plurality of reflectors are assigned for purposes of concentrating as much of the radiation as possible onto the packaging material and, if necessary, for focusing on regions of the latter.

The thermally-conductive carrier may also already be provided upstream and/or downstream of the, or each, drying station in the transport path of the flat packaging material. It can also take the form of a carrier that extends over the greater part of the transport path in the system, but which has means for adjusting its temperature, at least in the region of the drying station (s).

As cited in the independent claims, the invention is applicable to the processing of roll material, that is to say, quasi-endless webs that are pulled off a first web roller and wound onto a second web roller, as well as to the printing and drying of packaging material that exists in the form of individual sheets. Quasi-endless material usually has a lower material thickness of typically <100 μm, possibly even <10 μm, so that the parameters of the drying method (including the temperature and temperature homogeneity of the thermally-conductive carrier) have to be adjusted accordingly, while sheet material has a higher material thicknesses and the particular method parameters also have to be adjusted to this fact. These adjustments are, on the basis of the invention and the advantageous configurations cited below, within the scope of activity of a person skilled in the art.

In accordance with the various purposes of use of the flat printed packaging material, the latter takes the form of a polymer film, a textile web, or a cellulose/paper web, or a paper sheet, which, in particular, has a temperature resistance of up to a maximum of 100° C, in particular up to a maximum of 70° C. Such temperature-sensitive packaging materials can be dealt with by the method and the assembly in accordance with the invention in a particularly effective manner, both in terms of reliability, and with the assurance of quality.

In particularly practical embodiments of the method, printing is performed in an inkjet printing station using a water-based, or solvent-based, or hybrid, printing ink.

In the particular case of application of a solvent-based or hybrid printing ink, in addition to drying in the drying station, a curing of the ink is performed in a curing station, in particular by means of UV radiation or electron beams.

In advantageous embodiments of the method, the carrier is optionally heated or cooled over its entire width for purposes of temperature adjustment in the range between 35 and 70° C., in particular between 38 and 55° C. The temperature adjustment of the carrier is preferably performed with a temperature homogeneity of <±10° C., in particular of <±5° C. In a corresponding assembly the presence of heating and/or cooling devices corresponds to this form of method control, in conjunction with control means for the precise setting of the desired temperature, which means could also be designed as a control device with appropriate temperature sensor technology on the carrier or on the packaging material.

Both the temperature range and the high temperature homogeneity cited ensure a reliable drying of the printing for practically-relevant packaging material qualities and thicknesses, and thus a high quality of the end product, even when using particularly thin material and high transport and printing speeds.

If required, a further improvement can be achieved by attracting the web or sheet of packaging material onto the carrier, in particular by means of negative pressure or electrostatic attraction, to create a close thermally-conductive contact.

It is also advantageous for the web of packaging material to be transported with a predefined, in particular an adjustable, web tension that represents a minimum value with regard to the material quality and density.

In particular, in the case of very thin materials it is advantageous to implement a practically negligible web tension, whereby the transport of the material must, of course, still be ensured. For this purpose, it is envisaged that the web of the packaging material is guided over a transport roller or carrier roller, onto the surface of which the web is sucked, or in front of which the web is ionised so that it adheres to the surface of the roller by electrostatic attraction, so that the transport by means of the transport roller or carrier roller takes place solely by virtue of the rotation of the latter, with negligible web tension.

In a correspondingly designed embodiment of the assembly in accordance with the invention, a transport roller or carrier roller is arranged in the transport path of the web of packaging material, which transport roller or carrier roller has means for generating negative pressure or electrostatic attraction for purposes of attracting the web onto the surface of the transport roller or carrier roller, and so as to effect transport solely by virtue of the rotation of the transport roller or carrier roller, with negligible web tension. The means cited for creating negative pressure are known per se to the person skilled in the art, and may, for example, feature perforations of the transport roller or carrier roller that in terms of fluid flow are connected to a fan for purposes of creating a negative pressure inside the roller. Means for providing an electrostatic attraction between a plastic film or the like and a plastic or metal surface, over which this material is conveyed, are also basically of known art to the person skilled in the art.

A further advantageous configuration of the invention envisages that the flat packaging material is preheated by a temperature-controlled air flow, in particular in the form of an impingement flow in counterflow, before entry, or at the point of entry, into the drying station. Here the temperature-controlled air flow can in particular be generated by guiding a primary air flow through the radiation field of the near-infrared radiation, and/or by electrical heating. Investigations by the inventors have shown that a speed of the temperature-controlled air flow above 20 m/s, preferably above 30 m/s, is preferably set.

In a further advantageous embodiment, an extraction of air above the incoming printed packaging material is performed at the inlet to the drying station.

The aspects of the inventive device already ensue to a large extent from the aspect of the method as explained above, and these will therefore not be comprehensively described again. The following advantageous embodiments are particularly noteworthy, in terms of aspects of both the method and the device:

The method can then be implemented in a particularly compact system, if the one or plurality of printing station(s) and drying station (s) arranged over a part of the circumference of a drum that acts as a carrier for the flat packaging material.

In principle, however, it is also possible to arrange a sequence of pressure and drying station(s) along a linear transport path, whereby the thermally-conductive carrier with an adjustable temperature also extends linearly over at least part of this transport path (in the region of at least one drying station).

In further advantageous embodiments of the method and of the assembly, one ink colour is printed in each case by a plurality of printing units in the inkjet printing station, and when a flat packaging material with a temperature resistance in the range between 70° C. and 100° C. is used, a single drying station is arranged downstream of all printing units of the printing station. In an alternative embodiment, for use with a flat packaging material with a temperature resistance of up to 70° C., a drying sub-station is assigned to each printing unit, in each case for purposes of drying the ink previously applied.

In particular, the method is performed in such a way that in the first drying sub-stations no complete drying of the preceding printing is performed, but rather a pinning of the latter.

In a further configuration, after passing through a drying sub-station and before entering a subsequent printing sub-station, an intermediate cooling of the flat packaging material is performed.

In a further configuration of this method and assembly, it is envisaged that printing with black ink takes place in the inkjet printing station, and a separate drying sub-station is assigned to this printing unit.

In a further configuration of the method, the printing comprises a white printing in a white printing station, and a subsequent drying of the white printing in a white drying station. In particular, the drying in the white drying station comprises an irradiation with electromagnetic radiation, with a radiation density maximum in the near-infrared range, with a high power density, in particular one between 100 kW/m² and 1 MW/m².

In all method and assembly variants, an application of primer can be performed in a primer coating station, as can a subsequent drying of the primer in a primer drying station, before the printing of the flat packaging material. In this case, the drying in the primer drying station in particular comprises an irradiation with electromagnetic radiation, with a radiation density maximum in the near-infrared range, with a high power density, in particular one between 100 kW/m² and 1 MW/m².

In other configurations of the invention, it can be envisaged that after the printing and drying of the flat packaging material, a transparent top coating is applied in a coating station, and the top coating is dried in a downstream coating drying station. In particular, drying in the coating drying station comprises an irradiation with electromagnetic radiation, with a radiation density maximum in the near-infrared range, with a high power density, in particular one between 50 kW/m² and 500 kW/m².

Also in those configurations with a primer application and/or a top coat application, a configuration is advantageous in which a carrier of the printed packaging material, set to a predefined temperature, is also provided in the region of the corresponding drying station (s).

Further aspects and advantages of the present invention ensue from the following description of examples of embodiment, with the aid of the figures.

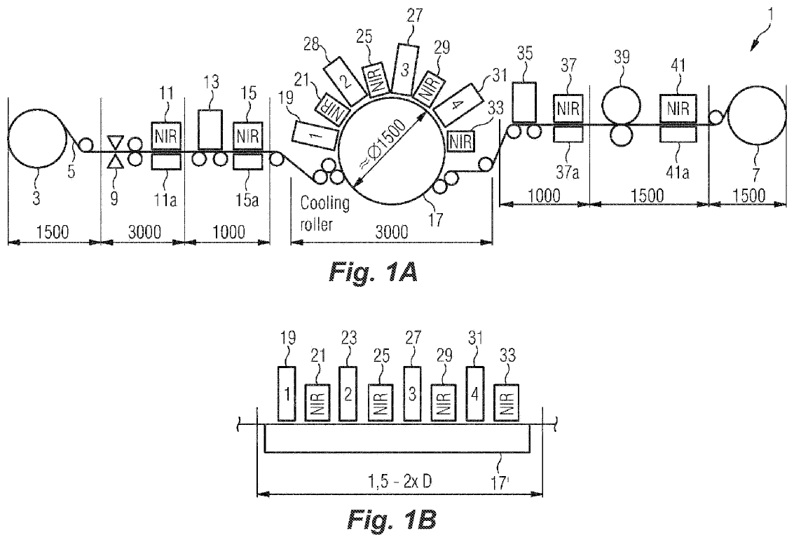

Of these, FIGS. 1 and 1A show a schematic sketch of an assembly in accordance with the invention, together with a design modification of the latter. In the lower part of the figures there are dimensions, which are merely exemplary, and are of secondary importance for the execution of the invention, and will therefore not be discussed further in what follows. The numerous running rollers and deflection rollers that can be seen in the figure are also not important in the implementation of the invention, and will therefore not be described further.

Accordingly, a system 1 for producing a flat printed packaging material comprises a first web roller 3 on which a quasi-endless web of a thin plastic film 5 is wound as the initial material. At the opposite end of the system is a second web roller 7, onto which the printed plastic film is wound. The second web roller 7 has a drive (not shown), with which the transport of the plastic film 5 through the system 1 is at least in part accomplished. Depending on the embodiment of the system, further drive elements can be provided.

Downstream of the first web roller 3 is a primer coating station 9 for purposes of applying a primer to the plastic film 5, and immediately downstream of this printing station 7 is a primer drying station 11, which operates with NIR radiation, and is designed to irradiate and dry the primer coating on the plastic film 5, with a power density of between 100 kW/m² and 1 MW/m². On the side of the plastic film opposite the NIR radiators of the drying station 11, there is a first thermally-conductive carrier section 11a with an adjustable temperature, over which the plastic film 5 slides, and which, in the first drying stage, in collaboration with the NIR radiators of the drying station, imposes a predefined temperature onto the film.

Downstream of the primer drying station 11 is a white printing station 15 for purposes of applying an at least partially flat white coating onto the plastic film 5, and immediately downstream of this is a white drying station 15, which in turn comprises an assembly of (in particular, linear) NIR radiators for purposes of imposing NIR radiation of a predefined high power density onto the white coating. As with the primer drying station, the white drying station 15 also has, on the opposite side of the plastic film 5, a (second) thermally-conductive carrier section 15a with an adjustable temperature.

Downstream of the white drying station 15, a rotating drum 17 is located in the system 1, over which the plastic film 5 is guided with, by way of example, an angle of wrap of between 240 and 270° , and over the surface of which a plurality of system components are arranged in the region in which the plastic film is wrapped around the latter. Following one another in the direction of travel of the plastic film 5, these system components are: four inkjet printing stations 19, 23, 27 and 31, in each case for one of the basic colours: magenta, yellow, cyan and black of a full-colour inkjet print, together with one NIR drying station 21, 25, 29 and 33 immediately downstream of the preceding printing station. Their layout corresponds in principle to the layout of the above-cited NIR drying stations arranged upstream. The specific operating parameters of each NIR drying station, in particular the position of the wavelength maximum and the power density on the surface of the packaging material, can be adapted to the colour, and, if necessary, also to the quantity per unit surface, of the respective coloured ink application.

Opposite all these components is, of course, the surface of the drum 17, which is made of a material that conducts heat well and thus acts as a solid thermally-conductive carrier for the plastic film 5 over the interrelated region of the above-cited system components. Means (not shown in the figure) are assigned to the drum 17 for the precise adjustment of its temperature within a predefined homogeneity range (see text above) . These means can take the form of heating and/or cooling devices, together with a control device.

Downstream of the drum 17 with the system components arranged above it, is arranged a further white printing station 35, to which in turn is assigned a (further) white drying station 37, opposite which is located a further thermally-conductive carrier section 37a with an adjustable temperature.

In turn, downstream of the second white drying station 37, a coating station 39 is provided for purposes of applying a top coat to the plastic film 5′ that has been fully printed and dried at this point in the system, and assigned to this final printing station is a coating drying station 41, again comprising NIR radiators, and designed to irradiate and dry the top coat with a power density over the full surfaces of between 50 kW/m² and 500 kW/m² before it is wound onto the second web roller 7. A thermally-conductive carrier section 41a with an adjustable temperature is once again assigned to this opposing drying station 41.

While the white and colour printing stations of the system could, in particular, be designed as inkjet printing stations, the print application and the application of the top coating can be performed in accordance with other application principles, in particular such as a squeegee blade coating or a roller coating.

While all the carriers or carrier sections facing the drying stations have been characterised above as thermally-conductive carriers with an adjustable temperature, such an embodiment is not essential to the invention. On the contrary, individual drying stations can also fulfil their task without opposing thermally-conductive carriers, and it is not absolutely necessary for all carrier sections to have means for a precise adjustment of their temperatures.

FIG. 1B shows a modification of the system 1 in FIG. 1A, namely an assembly of the system components in a linear sequence above a correspondingly linearly embodied thermally-conductive carrier 17′ with an adjustable temperature; the system components take the form of four inkjet printing stations 19, 23, 27 and 31 and in each case, immediately downstream, an NIR drying station 21, 25, 29 and 33.

With regard to the system components arranged above the drum 17 (in FIG. 1A) or the linear carrier 17′ (in FIG. 1B), it is expressly pointed out that these are only listed here as examples, and, depending on the specific printing design of the packaging film, more or fewer printing and drying components can be provided in varying assemblies. While the linear carrier (in a similar manner to the linear carrier sections in the other regions of the system in FIG. 1A) is shown in the form of a block in the figure, it can take the form of a thermally-conductive conveyor belt, and/or means for ensuring a closer mechanical contact with the plastic film can be assigned to the carrier, such as suction openings, or means for electrostatically attracting the film onto the carrier surface.

Furthermore, it is pointed out that a largely similar system configuration is also possible for the embodiment of the invention with packaging material (e.g. paper) preconfigured as material sheets, whereby a first and second sheet stack respectively take the place of the first and second web rollers, and means for the reliable separation of the material sheets fed to the printing and drying processes may be assigned to the first sheet stack. Normally, for the processing of sheets of material, the design with a linear carrier is more likely to be chosen from the associated system components, as shown in FIG. 1B.

With regard to the most efficient utilisation of the NIR radiation irradiated onto the packaging material, the surface of the carrier should have a high reflectivity of preferably more than 85%, in particular more than 90%, in its wavelength region. If necessary, this can be achieved by a correspondingly highly reflective and highly abrasion-resistant coating.

Furthermore, depending on the characteristics of the packaging material used and the printing to be applied, a variety of configurations of the system described here by way of example are possible in accordance with the forms of embodiment of the invention listed further above.

1. Method and assembly for producing a flat printed packaging material, comprising the steps:
providing a quasi-endless web of the packaging material on a first web roller, or
providing a sheet of the flat packaging material on a first sheet stack,
unwinding or receiving and transporting the packaging material through at least one printing station for purpose of printing a surface of the packaging material,
subsequently transporting the packaging material through at least one drying station in order to dry the printing on the packaging material, and
winding of the printed and dried packaging material onto a second web roller, or
depositing the printed and dried packaging material onto a second sheet stack,
characterised in that,
the drying process in the drying station comprises an irradiation process using electromagnetic radiation, with a radiation density maximum in the near-infrared range, with a high power density, in particular one between 100 and 800 kW/m², and wherein
the packaging material is transported at least through the drying station on a thermally-conductive carrier with an adjustable temperature.

2. Method according to claim 1, wherein the flat packaging material takes the form of a polymer film, a textile web, or a cellulose/paper web, or a paper sheet, which in particular has a temperature resistance up to a maximum of 100° C., in particular up to a maximum of 70° C.

3. Method according to claim 1, wherein the printing is performed in an inkjet printing station with a water-based, or solvent-based, or hybrid, printing ink.

4. Method according to claim 3, wherein when using a solvent-based, or hybrid, printing ink, in addition to the drying in the drying station, a curing of the ink is performed in a curing station, in particular by means of UV radiation or electron beams.

5. Method according to claim 1, wherein the carrier is optionally heated or cooled over its entire width for purposes of temperature adjustment in the range between 35 and 70° C., in particular between 38 and 55° C.

6. Method according to claim 1, wherein the temperature adjustment of the carrier is performed with a temperature homogeneity of <±10° C., in particular of <±5° C.

7. Method according to claim 1, wherein the web or sheet of packaging material is attracted onto the carrier, in particular by means of negative pressure or electrostatic attraction, so as to create a close thermally-conductive contact.

8. Method according to claim 1, wherein the web of the packaging material is transported with a predefined, in particular an adjustable, low web tension.

9. Method according to claim 8, wherein the web of the packaging material is guided over a transport or carrier roller, onto the surface of which the web is sucked, or in front of which the web is ionised, so that it adheres to the surface of the roller by means of electrostatic attraction, so that the transport by means of the transport or carrier roller takes place solely by virtue of its rotation, with negligible web tension.

10. Method according to claim 1, wherein the flat packaging material is preheated before, or on entry into, the drying station by means of a temperature-controlled air flow, in particular in the form of an impingement flow in counterflow, wherein the temperature-controlled air flow is generated in particular by guiding a primary air flow through the radiation field of the near-infrared radiation, and/or by electrical heating.

11. Method according to claim 10, wherein a speed of the temperature-controlled air flow is adjusted above 20 m/s, preferably above 30 m/s.

12. Method according to claim 1, wherein at the inlet to the drying station, air is extracted from above the incoming printed packaging material.

13. Method according to claim 1, wherein the one or plurality of printing station(s) and drying station(s) are arranged over part of the circumference of a drum, which acts as a carrier for the flat packaging material.

14. Method according to claim 3, wherein in the inkjet printing station, one ink colour is printed by each of a plurality of printing units and, when a flat packaging material with a temperature resistance in the range between 70° C. and 100° C. is used, a single drying station is arranged downstream of all the printing units of the printing station, while, when a flat packaging material with a temperature resistance of up to 70° C. is used, each printing unit is assigned a drying sub-station, in each case for purposes of drying the ink previously applied.

15. Method according to claim 14, wherein printing with black ink takes place in the inkjet printing station, and a separate drying sub-station is assigned to this printing unit.

16. Method according to claim 14, wherein in the first drying sub-stations, the preceding printing is not completely dried, but rather a pinning of the latter is performed.

17. Method according to claim 14, wherein after passing through a drying sub-station, and before entering a subsequent printing sub-station, an intermediate cooling of the flat packaging material is performed.

18. Method according to claim 3, wherein the printing process comprises a white printing in a white printing station. and a subsequent drying of the white printing in a white drying station, wherein in particular, the drying process in the white drying station comprises an irradiation with electromagnetic radiation, with a radiation density maximum in the near-infrared range, with a high power density, in particular one between 100 kW/m² and 1 MW/m².

19. Method according to claim 1, wherein prior to the printing of the flat packaging material, an application of primer is performed in a primer coating station, and a subsequent drying of the primer is performed in a primer drying station, wherein in particular, the drying process in the primer drying station comprises an irradiation with electromagnetic radiation, with a radiation density maximum in the near-infrared range, with a high power density, in particular one between 100 kW/m² and 1 MW/m².

20. Method according to claim 1, wherein after the printing and drying of the flat packaging material, a top coating is applied in a coating station, and the top coating is dried in a downstream coating/drying station, wherein in particular, the drying process in the coating/drying station comprises an irradiation with electromagnetic radiation with a radiation density maximum in the near-infrared range, with a high power density, in particular one between 50 kW/m² and 500 kW/m².

21. Assembly for the execution of the method in accordance with one of the preceding claims, having:
a first web roller, on which a quasi-endless web of a packaging material is provided, or
a first sheet stack, with a plurality of sheets of a sheet packaging material,
a transport device for purposes of unwinding the packaging material from the first web roller, or for purposes of picking up sheets of the packaging material from the first sheet stack, and transporting them to a second web roller, and winding them onto the latter, or transporting them to a second sheet stack, and depositing them onto the latter, along a transport path,
at least one printing station, arranged in the transport path downstream of the first web roller, or the first sheet stack, and
at least one drying station, arranged downstream of the printing station and upstream of the second web roller, or the second sheet stack, in the transport path,
characterised in that,
the drying station comprises means for the irradiation of the packaging material with electromagnetic radiation, with a radiation density maximum in the near-infrared range, with a high power density, in particular one between 100 and 800 kW/m², and
along the transport path, at least in the region of the, or a, drying station, a thermally-conductive carrier with an adjustable temperature is provided for the packaging material.

22. Assembly according to claim 21, wherein heating and/or cooling means are assigned to the thermally-conductive carrier for purposes of temperature adjustment in the range between 35 and 70° C., in particular between 38 and 55° C.

23. Assembly according to claim 21, wherein means for temperature adjustment, with a temperature homogeneity of <±10° C., in particular of <±5° C., are assigned to the thermally-conductive carrier.

24. Assembly according to claim 21, wherein means for generating negative pressure or electrostatic attraction are assigned to the thermally-conductive carrier so as to create a close thermally-conductive contact between the packaging material and the carrier.

25. Assembly according to claim 21, wherein in the transport path of the web of packaging material, a transport or carrier roller is arranged, which has means for generating negative pressure or electrostatic attraction so as to attract the web onto the surface of the transport or carrier roller, and so as to effect transport solely by virtue of the rotation of the transport or carrier roller, with negligible web tension.

26. Assembly according to claim 21, wherein the, or a, drying station is assigned to a curing station for purposes of curing ink applied to the packaging material in a printing station, which in particular has means for generating UV radiation or electron beams.

27. Assembly according to claim 21, wherein means for generating a temperature-controlled air flow, in particular in the form of an impingement flow in counterflow, are assigned to the, or each, drying station, wherein the temperature-controlled air flow is generated, in particular, by guiding a primary air flow through the radiation field of the near-infrared radiation, and/or by electrical heating.

28. Assembly according to claim 21, wherein at the inlet to the, or each, drying station, means are assigned for extracting air from above the incoming printed packaging material.

29. Assembly according to claim 21, wherein the printing station comprises a plurality of printing units, and a drying sub-station is assigned to each printing unit, in each case for purposes of drying the ink previously applied.

30. Assembly according to claim 29, wherein means for the intermediate cooling of the flat packaging material are arranged after at least one drying sub-station.

31. Assembly according to claim 21, wherein the one or plurality of printing station(s) and drying station(s) are arranged over a part of the circumference of a drum, which acts as a carrier for the flat packaging material.

32. Assembly according to claim 21, wherein a primer coating station for a primer application onto the flat packaging material is arranged upstream of the, or the first, printing station, and a primer drying station is arranged immediately downstream of the primer coating station, wherein the primer drying station has means for generating electromagnetic radiation with a radiation density maximum in the near-infrared range, with a high power density, in particular one between 100 kW/m² and 1 MW/m².

33. Assembly according to claim 21, wherein downstream of the printing station(s) for printing the packaging material and drying station(s) for drying the printed packaging material, a coating station for applying a top coating and, immediately downstream of the latter, a coating drying station for drying the top coating, are arranged, wherein the coating drying station has means for generating electromagnetic radiation with a radiation density maximum in the near-infrared range, with a high power.
